(19) United States
(12) Patent Application Publication
(10) Pub. No.: US 2011/0023867 A1
(43) Pub. Date: Feb. 3, 2011

(54) Method and System for Supporting Solar Panels

(75) Inventors: David J. Muchow, Arlington, VA (US); Adam Gutman, Arlington, VA (US); Sara V. Zulkosky, Arlington, VA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SkyBuilt Power, Inc.

(21) Appl. No.: 12/846,694

(22) Filed: Jul. 29, 2010

Related U.S. Application Data
(60) Provisional application No. 61/213,934, filed on Jul. 30, 2009.

(51) Int. Cl. F24J 2/52; B23P 19/04

(52) U.S. Cl. 126/623; 29/428

(57) ABSTRACT

An assembly for supporting at least one solar panel includes two side brackets. Each side bracket includes a top member having an L-shaped cross-section with a top portion substantially perpendicular to a side portion, a bottom member having an L-shaped cross-section with a bottom portion substantially perpendicular to a side portion, and a height adjustment mechanism connecting the side portions. The height adjustment mechanism is configured to adjust a height between the top and bottom members so that the top and bottom portions of each side bracket clamp onto respective top and bottom surfaces of at least one solar panel. The assembly also includes a width adjustment mechanism connecting the two side brackets and configured to adjust a width between the two side brackets. At least one of the side brackets includes a first connector configured to electrically connect to a second connector on the at least one solar panel.

### PRIORITY

This application claims the benefit of priority from U.S. Provisional Application No. 61/213,934, filed Jul. 30, 2009, which is herein incorporated by reference in its entirety.

### TECHNICAL FIELD

This disclosure relates generally to a method and a system for supporting solar panels, and more particularly, to an adjustable system for supporting at least one solar panel.

### BACKGROUND

While electric power from traditional electrical power grids is readily available in many locations throughout the world, there remain vast regions where no electric power is available. Even in locations where electric power is available, there is a variety of situations where a supplemental or substitute power source would be desirable.

Solar panels for generating power are known and may be applied in many different applications. Conventional solar panels, however, have several shortcomings. For example, some conventional solar panels are permanently and mechanically attached to roofs, walls, or other surfaces. As a result, these conventional solar panels may be more difficult to remove or replace with new solar panels. In addition, some conventional solar panels are permanently electrically-wired, which may make them more difficult to install or replace with new solar panels.

It is to be understood that both the foregoing general description and the following detailed description are exemplary and explanatory only and are not restrictive of the invention.

### SUMMARY

In accordance with an embodiment, an assembly for supporting at least one solar panel includes two side brackets. Each side bracket includes a top member having an L-shaped cross-section with a top portion substantially perpendicular to a side portion, a bottom member having an L-shaped cross-section with a bottom portion substantially perpendicular to a side portion, and a height adjustment mechanism connecting the side portions of the top and bottom members. The height adjustment mechanism is configured to adjust a height between the top and bottom members so that the top and bottom portions of each side bracket clamp onto respective top and bottom surfaces of at least one solar panel. The assembly also includes a width adjustment mechanism connecting the two side brackets and configured to adjust a width between the two side brackets. At least one of the side brackets includes a first connector configured to electrically connect to a second connector on the at least one solar panel.

In accordance with a further embodiment, a skylight assembly for supporting a solar array includes a cover configured to close an opening in a roof surface to form a skylight and having an adjustable angle of inclination to adjust an extent to which the cover closes the opening. The skylight assembly also includes a rack connectable to a support, and the support is configured to be positioned horizontally or at an angle of inclination. The skylight assembly further includes at least one solar panel configured to be connected to the rack such that an angle of inclination of the at least one solar panel varies with the angle of inclination of the support. The at least one solar panel is detachable from the rack.

In accordance with another embodiment, a method of supporting at least one solar panel includes adjusting a width between two side brackets using a width adjustment mechanism connecting the two side brackets and inserting at least one solar panel into the two side brackets so that the side edges of the at least one solar panel are received within the respective side brackets. The method also includes adjusting a height between a top member and a bottom member of each of the side brackets using height adjustment mechanisms of the respective side brackets, and clamping the side brackets onto the respective side edges of the at least one solar panel. The method further includes automatically electrically connecting the at least one solar panel to at least one of the side brackets when the at least one solar panel is inserted into the two side brackets and placed at a desired position with respect to the two side brackets.

Additional objects and advantages of the invention will be set forth in part in the description which follows, and in part will be obvious from the description, or may be learned by practice of the invention. The objects and advantages of the invention will be realized and attained by means of the elements and combinations particularly pointed out below.

It is to be understood that both the foregoing general description and the following detailed description are exemplary and explanatory only and are not restrictive of the invention.

### BRIEF DESCRIPTION OF THE DRAWINGS

The accompanying drawings, which are incorporated in and constitute a part of this specification, illustrate several embodiments of the invention and together with the description, serve to explain the principles of the embodiments.

FIGS. 1-4 show a rack configured to support one or more solar panels, according to an exemplary embodiment;

FIG. 5 shows a rack configured to support solar panels of different widths, according to another exemplary embodiment;

FIG. 6 shows the connection between the solar panel and a side bracket of the rack of FIGS. 1-4;

FIGS. 7-11 show the rack of FIGS. 1-4 detachably connected to a mounting structure including legs;

FIGS. 12 and 13 show the rack of FIGS. 1-4 detachably connected to a dual-axis mounting structure;

FIGS. 14 and 15 show the rack of FIGS. 1-4 detachably connected to a mounting structure forming a panel for a roof;

FIGS. 16-18 show the rack of FIGS. 1-4 detachably connected to a mounting structure forming a panel for a skylight;

FIGS. 19 and 20 show a wind turbine supported by a pole embedded into a building structure formed by interlocking structural panels, according to an exemplary embodiment;

FIG. 21 shows components embedded into interlocking structural panels for forming a building structure, according to an exemplary embodiment; and

FIGS. 22-24 show a building structure formed by interlocking structural panels, according to an exemplary embodiment.

### DESCRIPTION OF THE EMBODIMENTS

Reference will now be made in detail to exemplary embodiments of the invention, examples of which are illustrated in the accompanying drawings. Wherever possible, the same reference numbers will be used throughout the drawings to refer to the same or like parts.

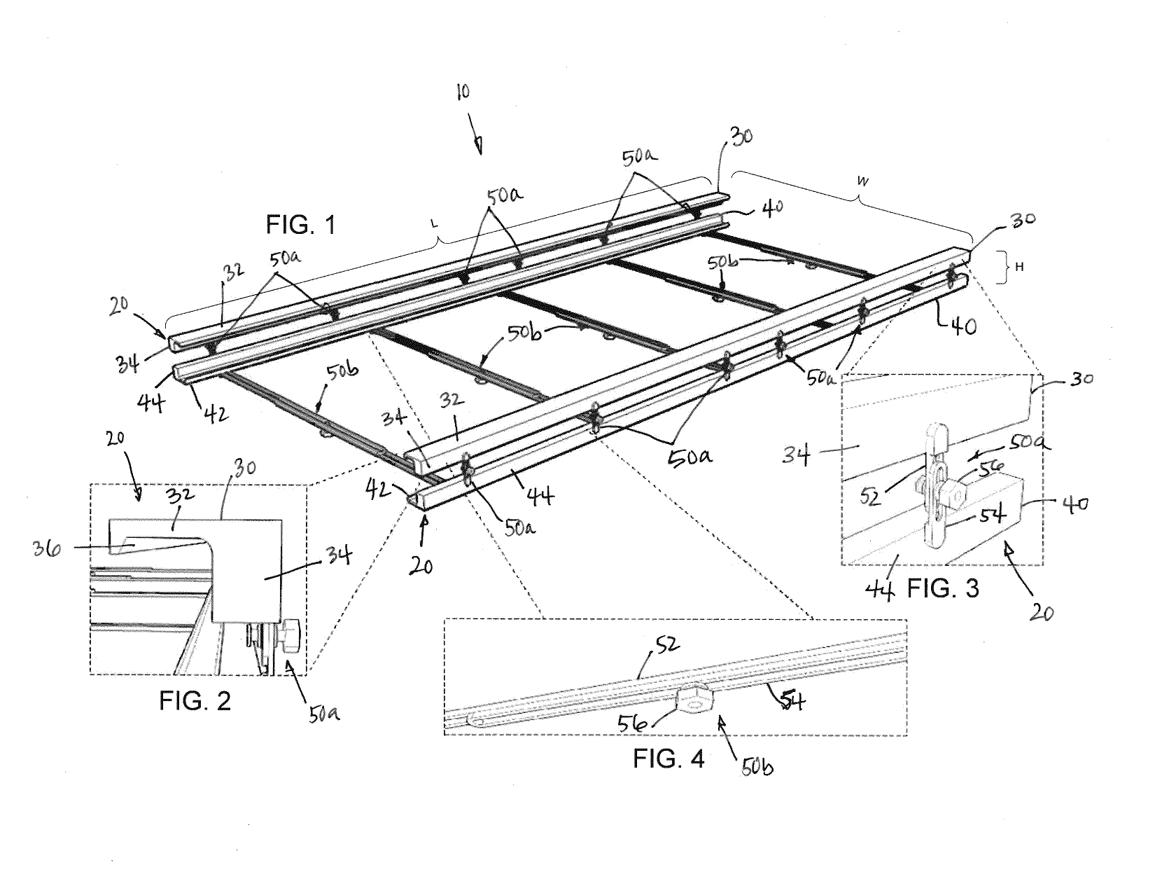

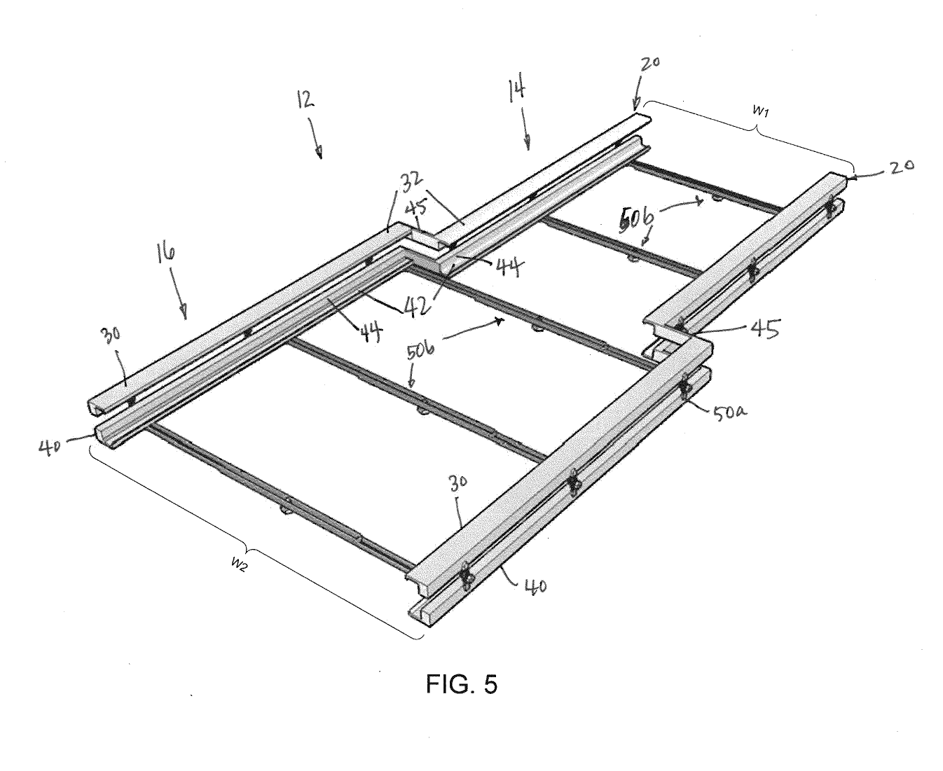

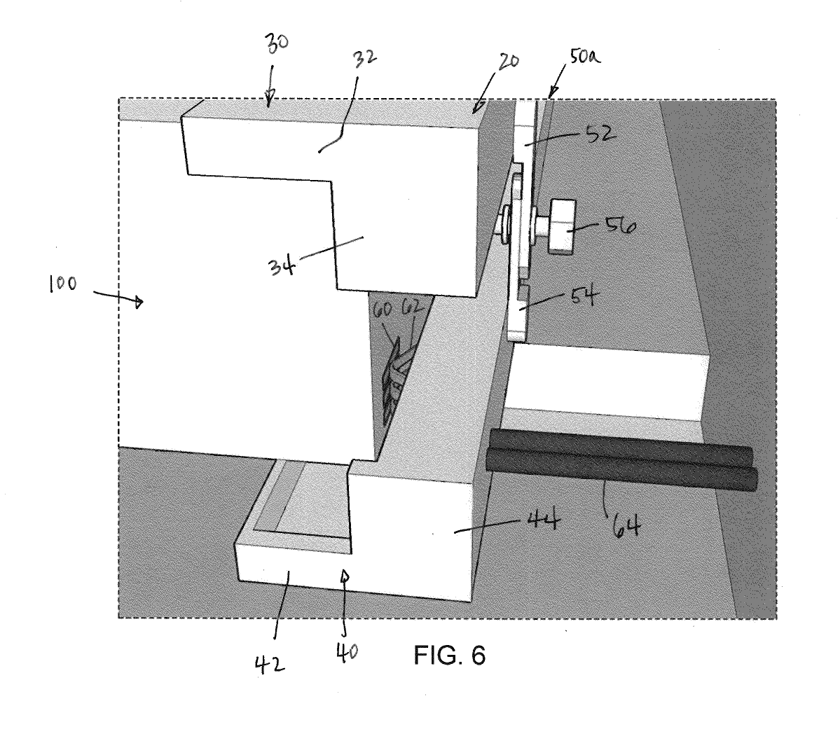

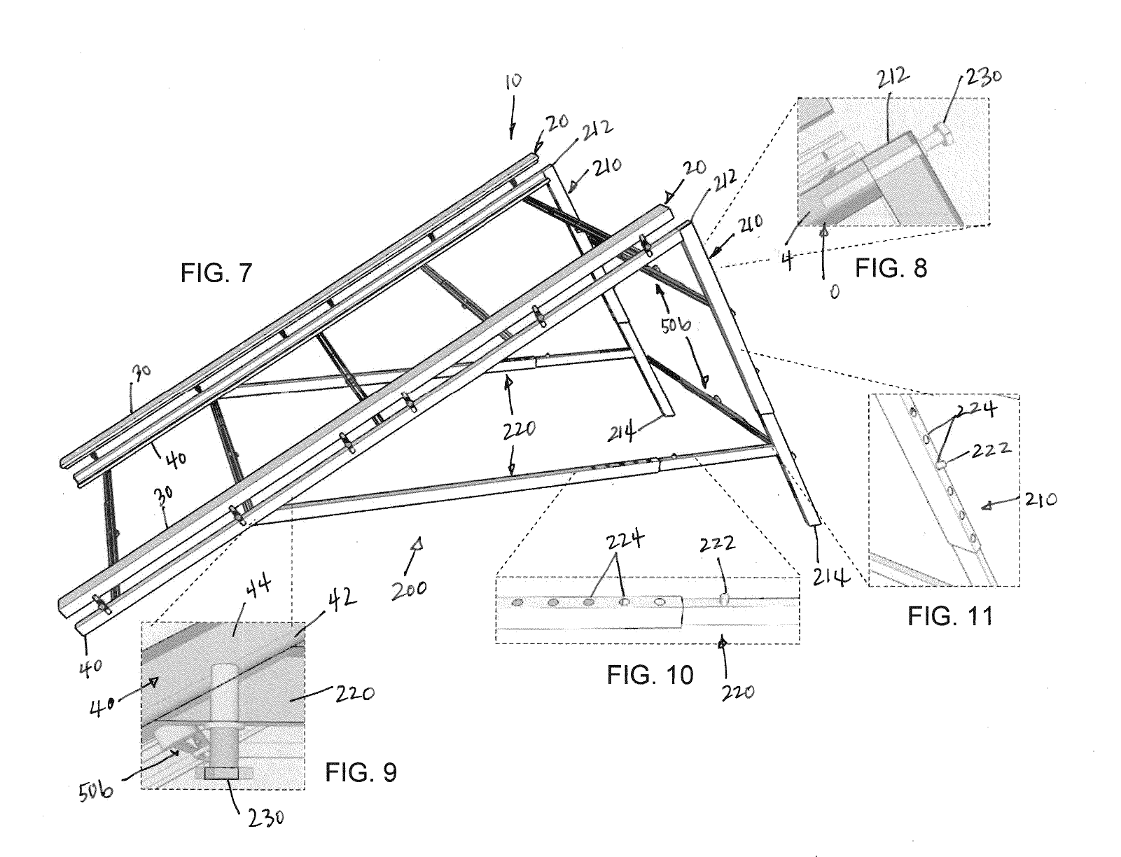

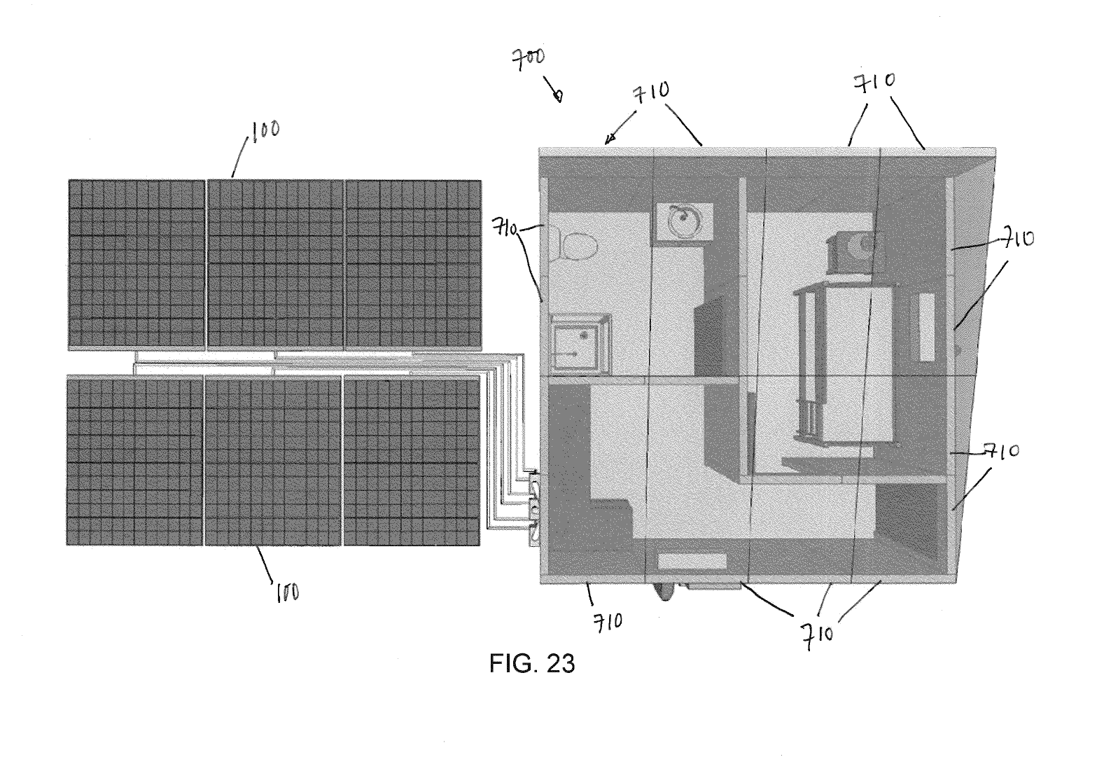

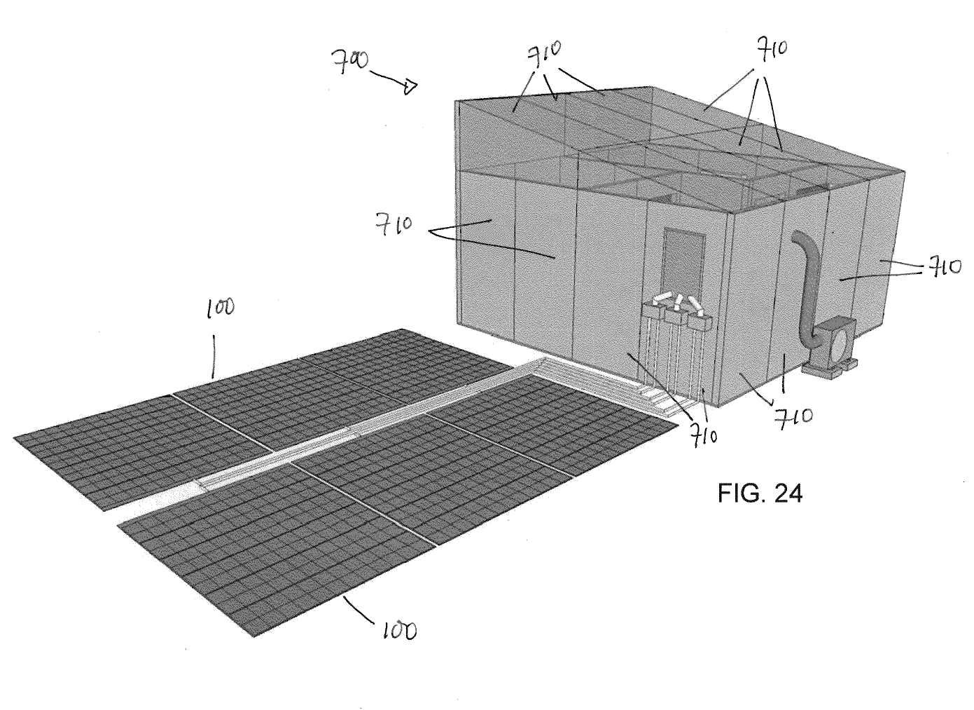

FIGS. 1-4 show an exemplary embodiment of a rack 10 configured to hold one or more solar panels 100 (photovoltaic (PV) panels) (FIGS. 6 and 22-24). In the embodiment shown in FIGS. 1-4, the rack 10 is adjustable in height H and width W to accommodate various sizes of solar panels. For example, the rack 10 shown in FIGS. 1-4 may accommodate multiple solar panels 100 of the same width W and height H. The solar panels 100 may be positioned next to each other along the length L of the rack 10. Alternatively, the rack 10 may also be adjustable in length L.

The rack 10 includes a pair of side brackets 20. Each side bracket 20 includes a top member 30, a bottom member 40, and one or more height adjustment mechanisms 50a. FIG. 2 shows the cross-section of the top member 30, which includes a substantially L-shaped cross-section with a top portion 32 substantially perpendicular to a side portion 34. The bottom member 40 also includes a substantially L-shaped cross-section formed with a bottom portion 42 substantially perpendicular to a side portion 44. As shown in FIG. 1, the top and bottom members 30, 40 may be substantially identical and generally form mirror images of each other with respect to a plane separating the top and bottom members 30, 40.

FIG. 3 shows an exemplary embodiment of the height adjustment mechanism 50a. The height adjustment mechanism 50a in each side bracket 20 is configured to adjust the distance between the top and bottom members 30, 40 and to also adjust the height H of the rack 10. The height adjustment mechanism 50a connects the side portions 34, 44 of the top and bottom members 30, 40, and is configured to adjust the distance between the top and bottom members 30, 40 so that the top and bottom portions 32, 42 of each side bracket 20 may clamp onto respective top and bottom surfaces of the solar panel(s) 100 along the side edges of the solar panel(s) 100, as shown in FIG. 6.

The rack 10 also includes one or more width adjustment mechanisms 50b connecting the side brackets 20, as shown in FIG. 1. FIG. 4 shows an exemplary embodiment of the width adjustment mechanism 50b, which is configured to adjust the distance between the side brackets 20 and to also adjust the width W of the rack 10. The width adjustment mechanism 50b may connect to an underside surface of the bottom portions 42 of the bottom members 40 of the side brackets 20 and is configured to adjust the distance between the side brackets 20 so that the side brackets 20 may be positioned over the side edges of the solar panel(s) 100, as shown in FIG. 6.

Each of the adjustment mechanisms 50a, 50b may include a first member 52, a second member 54, and a fastening member 56 connecting the first and second members 52, 54. For example, the first and second members 52, 54 may include respective slots that align with each other, and the fastening member 56 may be inserted through the respective slots. The first and second members 52, 54 may slide toward or away from each other so that the opposite ends of the first and second members 52, 54 are moved toward each other (to contract the adjustment mechanism 50a, 50b) or away from each other (to expand the adjustment mechanism 50a, 50b). For example, as shown in FIG. 3, the opposite ends of the first and second members 52, 54 of the height adjustment mechanism 50a are attached to the respective side portions 34, 44 of the top and bottom members 30, 40. As shown in FIG. 4, the opposite ends of the first and second members 52, 54 of the width adjustment mechanism 50b are attached to the respective underside surfaces of the side brackets 20.

The fastening member 56 may include a nut and bolt as shown in FIGS. 1-4, or other device configured to lock the first and second members 52, 54 in position with respect to each other or to allow movement between the first and second members 52, 54. The first member 52 may be configured to move with respect to the second member 54 to adjust the respective height H or width W of the rack 10 when the fastening member 56 is loosened, and the first member 52 may be prevented from moving with respect to the second member 54 when the fastening member 56 is tightened.

Alternatively, each side bracket 20 may also include length adjustment mechanisms (not shown) that allow a user to adjust the length of the respective side bracket 20 and therefore the length L of the rack 10. The length adjustment mechanism may be similar to the height and width adjustment mechanisms 50a, 50b. For example, each side bracket 20 may include two adjacent top members 30 and two adjacent bottom members 40. One length adjustment mechanism may connect and adjust the distance between the two adjacent top members 30, and another length adjustment mechanism may connect and adjust the distance between the two adjacent bottom members 40.

FIG. 5 shows an exemplary embodiment of a rack 12 configured to hold solar panels 100 of different widths. The rack 12 includes a first section 14 having a width W1 and a second section 16 having a width W2 that is larger than the width W1. Thus, solar panels of different widths may be clamped into the rack 12 with wider solar panels being clamped into the second section 16. While shown as having a fixed size ratio, the widths W1, W2 of each section 14, 16 may also be independently adjustable. For example, an adjustment mechanism (e.g., an adjustment mechanism as described above) (not shown) may adjust the distance along the widthwise direction at a location 45 between the adjacent top and bottom members 30, 40 of each side bracket 20 of the respective sections 14, 16. As another alternative, the heights H of each section 14, 16 may also be independently adjustable. For example, the top member 30 of each side bracket 20 may be formed in sections that are independently adjustable to provide different heights H. It is understood that the rack 12 may be substituted for the rack 10 in any of the embodiments described below.

FIG. 6 shows the side edge of the solar panel 100 inserted into one of the side brackets 20. The solar panel(s) 100 are inserted between the top portion 32 of the top member 30 and the bottom portion 42 of the bottom member 40 of the side brackets 20.

The solar panel(s) 100 may be individually replaceable. For example, when the rack 10 supports multiple solar panels 100, the side brackets 20 may be opened by expanding the height adjustment mechanisms 50a. The user may remove any solar panels 100 to be replaced from between the side brackets 20 (e.g, by sliding the solar panels 100 along the lengthwise dimension), and the new solar panels 100 may be inserted between the side brackets 20 in place of the removed solar panels 100. Then, when the solar panels 100 have been positioned as desired, the height adjustment mechanisms 50a may be adjusted so that the side brackets 20 may clamp onto the solar panels 100.

The rack 10 may be flexible (e.g., made of flexible materials) to more easily accommodate solar panels 100 of different sizes. Also, the rack 10 may be foldable to reduce its size, for example, if removed for transport. The solar panel 100 may be secured by adjustable latches or other mechanisms (not shown), and such securing mechanisms may have a design, such as a ridge 36 (FIG. 2), to secure the solar panel 100 in the desired position.

FIG. 6 also shows an electrical connection between the solar panel 100 and the rack 10. Each solar panel 100 may include a conductive strip 60, and at least one of the side brackets 20 may include a spring-loaded connector 62. The spring-loaded connector 62 may be connected to wiring 64 that connects the side bracket 20 to an external device (not shown). For example, the wiring 64 may output power generated by the solar panel 100 to a storage device (not shown) or other external device.

The spring-loaded connector 62 may be configured to electrically connect to the conductive strip 60 when the solar panel 100 is placed into a desired position on the rack 10 and in the side brackets 20. Thus, the electrical connection may be established automatically, e.g., without having to manually connect (e.g., using hands or instruments) an electrical connector on the solar panel 100 to a corresponding electrical connector on the rack 10. When the solar panel 100 is positioned and secured to the rack 10, the conductive strip 60 and the spring-loaded connector 62 automatically align and connect to each other to form the electrical connection. Alternatively, other types of connectors that permit an electrical connection (automatic or manual) between the solar panel 100 and the rack 10 may be used.

As shown in FIG. 6, the conductive strip 60 may be located on an outer perimeter surface of the solar panel 100. The spring-loaded connector 62 may be located on an inside surface of the side portion 44 of the bottom member 40 facing the outer perimeter surface of the solar panel 100. Alternatively, the spring-loaded connector 62 may be located on an inside surface of the side portion 34 of the top member 30.

In the exemplary embodiment shown in FIG. 6, each solar panel 100 includes a female connector, e.g., the conductive strip 60, and the side bracket 20 includes the male connector, e.g., the spring-loaded connector 62. Alternatively, the side bracket 20 may include the female connector and each solar panel 100 may include the male connector. Also, adjacent solar panels 100 may electrically connect to each other when the solar panels 100 contact each other when placed adjacent to each other on the rack 10, e.g., using the conductive strip 60, the spring-loaded connector 62, or other the female and male connectors. The connectors may be placed on the outer perimeter surfaces that face each other on the adjacent solar panels 100. Furthermore, the side bracket 20 may include a row of spaced spring-loaded connectors 62 positioned along the inside surface of the side portion 44 of the bottom member 40 to attach to multiple solar panels 100 placed in the rack 10.

The rack 10 may be detachably connected to various external mounting structures, and the external mounting structures may be provided on the ground, on building structures (e.g., on a roof of the building structures), etc. Exemplary embodiments of the various external mounting structures are shown in FIGS. 7-18.

FIGS. 7-11 show an exemplary embodiment of a mounting structure 200 including legs 210 that each include a first end 212 and a second end 214. The first ends 212 of the legs 210 support and connect to one end of the rack 10, and the second ends 214 of the legs 210 are located in the same horizontal plane as the other end of the rack 10. As shown in FIG. 7, the second ends 214 of the legs 210 and the free end of the rack 10 may be located in the same horizontal plane, e.g., on the ground or other surface. The legs 210 may be connected to each other by one or more width adjustment mechanisms 50b. The legs 210 may have cross-sections of different shapes, e.g., cylindrical, rectangular, etc.

The legs 210 may also be connected to the rack 10 by connecting bars 220, which may be generally horizontal. FIGS. 8 and 9 show that the mounting structure 200 is detachably connected to the rack 10 using screws or other fastening members 230. For example, the fastening members 230 may detachably connect the first ends 212 of the legs 210 to the ends of the side portions 44 of the bottom members 40 of the respective side brackets 20. The fastening members 230 may also detachably connect the ends of the connecting bars 220 to the bottom portions 42 of the bottom members 40 of the respective side brackets 20.

As shown in FIG. 7, the legs 210 and the connecting bars 220 may be expandable. For example, in the embodiment shown in FIGS. 7-11, the legs 210 and the connecting bars 220 are telescoping poles including inner poles and outer poles. The inner poles of the legs 210 and the connecting bars 220 may be integrally formed as shown in FIG. 7. Thus, the lengths of the legs 210 and the connecting bars 220 may vary to adjust the height and angle of inclination of the rack 10.

As shown in FIGS. 10 and 11, the lengths of the legs 210 and the connecting bars 220 may be set, for example, using spring-loaded pins 222 on the inner poles that may be inserted through one of multiple holes 224 formed in the outer poles of the legs 210 and the connecting bars 220. The pins 222 lock the inner poles in position with respect to the outer poles of the legs 210 and the connecting bars 220. Thus, the mounting structure 200 is manually adjustable to set the height and angle of inclination of the rack 10, e.g., to create different angles for longer term installations.

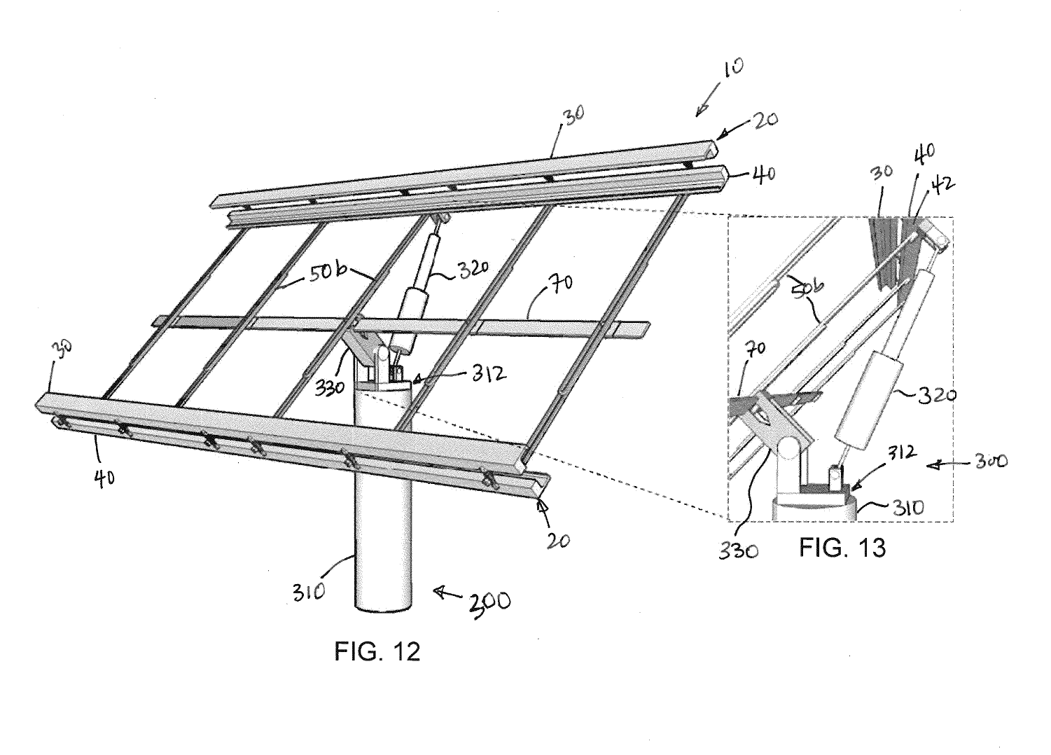

FIGS. 12 and 13 show an exemplary embodiment of a mounting structure 300 including a pole 310 configured to vertically support the entire rack 10 above the ground. The mounting structure 300 also includes an extendable arm 320. The arm 320 may be a telescoping pole, such as a fluid (air or liquid) hydraulic system or other actuator, that is pivotably connected at one end to a top end 312 of the pole 310 and pivotably connected at the other end to the rack 10 (e.g., the underside surface of the bottom portion 42 of one of the bottom members 40). The arm 320 may be extendable to adjust the angle of inclination of the rack 10 and to rotate the rack 10 about an axis extending parallel to the lengthwise dimension of the rack 10.

The rack 10 may include a central support bar 70 connected to and extending perpendicular to the width adjustment mechanisms 50b. The pole 310 may be pivotably connected to the central support bar 70, e.g., using a pivotable connector 330. The pivotable connector 330 may be configured to snap onto the central support bar 70 and may be detachable from the central support bar 70.

The arm 320 and the pivotable connector 330 may both be attached to and pivotable with respect to the top end 312 of the pole 310. In addition, the top end 312 of the pole 310 may be rotatable with respect to an axis of the pole 310, e.g., using a motor or other actuator. Thus, the mounting structure 300 may be a dual-axis solar tracking system configured to rotate the rack 10 about the axis of the pole 310 due to the rotation about the top end 312 of the pole 310 and configured to rotate the rack 10 about an axis extending parallel to the lengthwise dimension of the rack 10 due to the extension of the arm 320. The ability to perform dual-axis rotation may allow for automatic tracking of the sun.

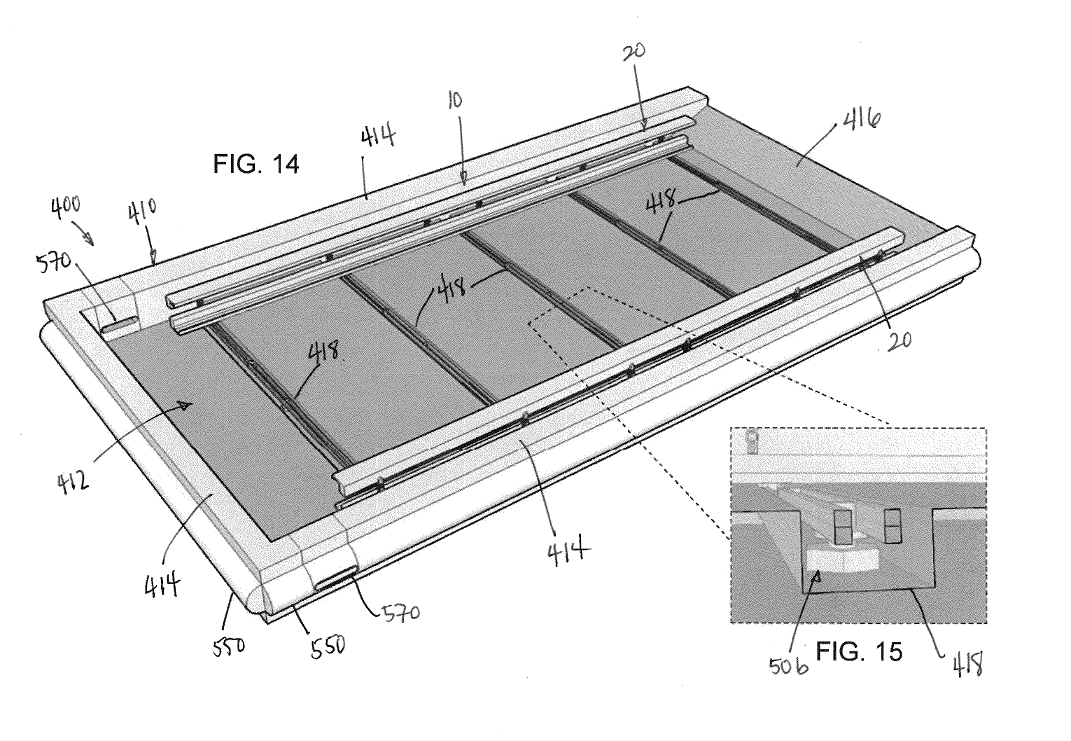

FIGS. 14 and 15 show an exemplary embodiment of a mounting structure 400 including a panel 410 for a roof of a building structure, or other portion of a wall, roof, panel for forming a building structure, etc. The panel 410 may include a recess 412 in which the rack 10 may be located. As shown in FIG. 14, the side brackets 20 and the width adjustment mechanisms 50b of the rack 10 may lie partially or completely inside the recess 412. A top surface of the solar panels 100 or a top surface of the top members 30 of the side brackets 20 may be flush with the top surface of the panel 410 or recessed into the panel 410. The recess 412 may be formed within three walls 414 with an open side that may form a slide-in area 416 that allows access to the rack 10 so that the solar panels 100 may be inserted into and removed from the rack 10 through the slide-in area 416.

The rack 10 may be detachably connected to the panel 410, e.g., using screws or other fasteners to connect the bottom members 40 of the side brackets 20 and/or the width adjustment mechanisms 50b to a surface in the recess 412 of the panel 410. As shown in FIG. 15, the surface in the recess 412 of the panel 410 may be formed with grooves 418 for receiving the width adjustment mechanisms 50b or other portions of the rack 10 when the rack 10 is connected to the panel 410.

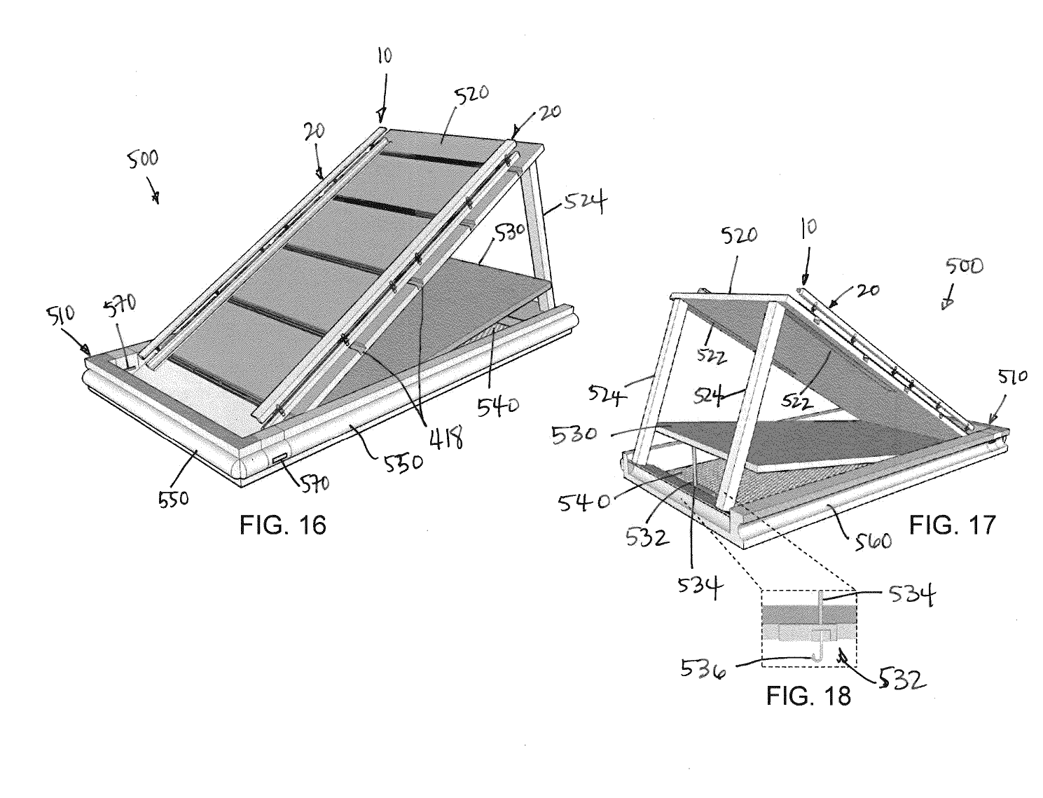

FIGS. 16-18 show an exemplary embodiment of a mounting structure 500 including a panel 510 for a roof of a building structure. The panel 510 is configured to be positioned over an opening in the roof forming a skylight. The panel 510 includes a support 520 for the rack 10 and a cover 530 configured to close the opening in the roof. Alternatively, the cover 530 may be omitted, and the support 520 may be configured to close the opening in the roof.

The rack 10 may be detachably connected to the support 520, e.g., using screws or other fasteners to connect the bottom members 40 of the side brackets 20 and/or the width adjustment mechanisms 50b to a top surface of the support 520. The top surface of the support 520 may include the grooves 418 described above for receiving the width adjustment mechanisms 50b or other portions of the rack 10 when the rack 10 is connected to the support 520.

The panel 510 may include a hinged adjustment mechanism (not shown) connected to an end of the support 520 to allow the support 520 to pivot to different angles of inclination with respect to the panel 510, as shown in FIGS. 16 and 17, or to be positioned horizontally. The bottom surface of the support 520 may include slots 522 (FIG. 17) for slidably receiving ends of respective legs 524. The opposite ends of the legs 524 may be pivotably attached to an end of the panel 510. The legs 524 hold the support 520 at a particular angle of inclination and may be adjustable in length to adjust the angle of inclination of the support 520. Thus, the angle of inclination of the support 520 determines an angle of inclination of the rack 10. The slots 522 may be sized to receive the legs 524 when the support 520 is positioned horizontally so that the support 520 may lie completely flat with respect to the panel 510.

The support 520 may be positioned at various angles of inclination to reveal the cover 530 and the opening in the roof when the cover 530 is open. The support 520 overlies the cover 530 when the support 520 is positioned horizontally. When the support 520 is horizontal, the rack 10 may be partially or completely recessed in the panel 510. The angle of inclination of the cover 530 is also adjustable, and the angle of inclination of the cover 530 affects the extent to which the cover 530 closes the opening in the roof forming the skylight. The panel 510 may include a skylight adjustment mechanism 532 attached to the cover 530 and configured to control the extent to which the cover 530 closes the opening in the roof. For example, the skylight adjustment mechanism 532 may include an arm 534 connected to an end of the cover 530, which is pivotally attached at its opposite end to the panel 510. The arm 534 may include a handle 536 for the user to manually raise the arm 534, thereby causing the cover 530 to pivot with respect to its connection to the panel 510. When the cover 530 is opened as shown in FIGS. 16 and 17, the cover 530 allows light to enter the skylight, and allows air to enter or be exhausted, e.g., through a screen 540. As a result, the mounting structure 500 may combine the solar array 100 and the skylight in one assembly to save space and increase usability.

Thus, FIGS. 14-18 show embodiments of mounting structures 400, 500 including panels 410, 510 for a roof of a building structure, or other portion of a wall, roof, panel for forming a building structure, etc. These panels 410, 510 may include enclosed areas 570 (FIGS. 14 and 16) through which electrical wiring or other electrical connections (such as the wiring 64 shown in FIG. 6) may pass. The electrical wiring or other electrical connections passing between the panels 410, 510 and the solar panels 100 held in the rack 10 may be sealed in water resistant areas or by water resistant gaskets. A drainage system may also be included in the panels 410, 510.

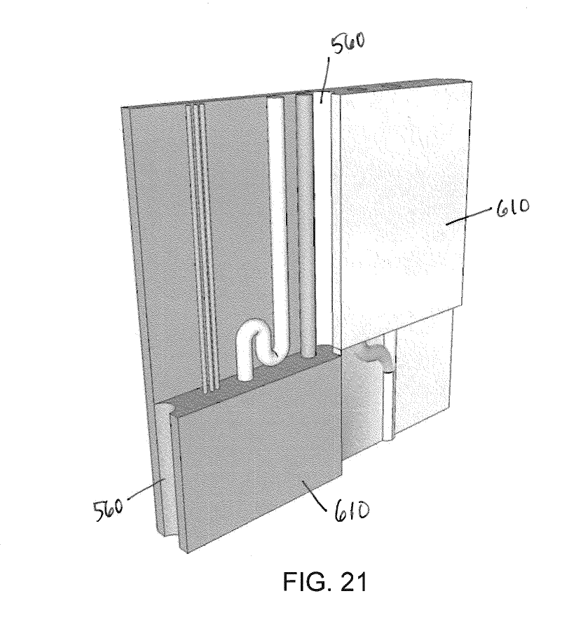

The panels 410, 510 may be modular and may be shipped to a building site and rapidly assembled by putting them together with cam locks and/or other mechanisms, such as an interlocking mechanism including a tongue 550 (FIGS. 14 and 16) and groove 560 (FIGS. 17 and 21) on the panels 410, 510. The structural panels (including the panels 410, 510) may also be fixed and secured together using various other methods for increasing the stability of the connections joining the structural panels. Since the solar panel(s) 100 and the rack 10 may be partially or completely recessed in the panels 410, 510, the panels 410, 510 may be shipped flat and rapidly assembled into structures in the field with renewable energy devices (the solar panel(s) 100), the rack 10, and other systems already embedded in the panels 410, 510.

The rack 10 may be attached to the panels 410, 510 or other mounting structures by an easy-to-use snap-in mechanism or some other connecting mechanism. This connecting mechanism may have the ability to conduct heat to or away from the solar panel(s) 100. Conducting heat away from the solar panel(s) 100 into the rack 10 may help lower the temperature of the solar panel(s) 100 in warm conditions and may improve the efficiency of the solar panel(s) 100. This connection may be made of different types of materials with different conductive properties.

The rack 10 is configured to detachably connect to any of the mounting structures 200, 300, 400, 500. The rack 10 may be removed from any of the mounting structures 200, 300, 400, 500 described above and attached to a different type of mounting structure 200, 300, 400, 500. For example, the rack 10 may be attached to and then detached from the mounting structures 400, 500 provided on a roof of a structure. Then, the rack 10 may be attached to one of the mounting structures 200, 300, e.g., provided on the ground. Alternatively, the rack 10 maybe attached to and then detached from the mounting structures 200, 300, e.g., provided on the ground, and then attached to one of the mounting structures 400, 500 provided on a roof of a structure.

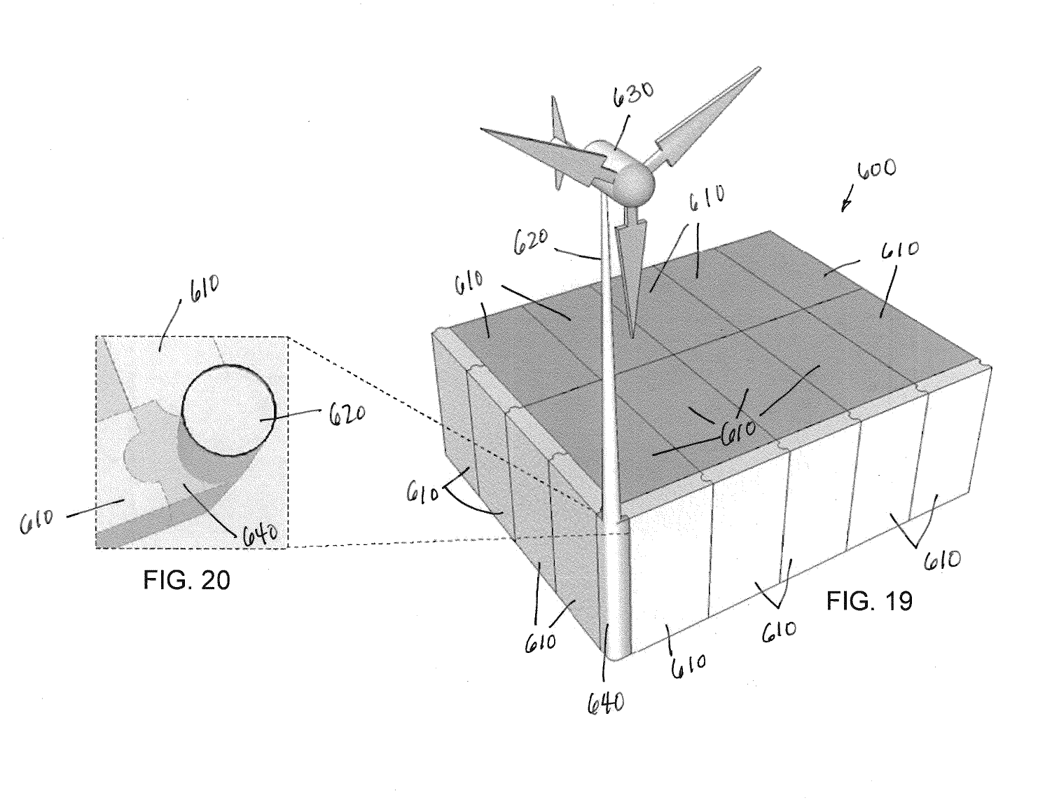

FIGS. 19 and 20 show a building structure 600 formed by structural panels 610 and including a pole 620 that supports a wind turbine 630. The pole 620 may be formed integral with, inserted into, or connected to a joint 640 between the structural panels 610. As shown in FIG. 20, the pole 620 may fit in with the structural panels 610 through the same tongue and groove design with cam locks as described above, and the tongue and groove connection may be integrally formed in the respective surfaces of the joint 640 and the structural panels 610. The wind turbine 630 may be positioned at a corner of the structure 600. Alternatively, the wind turbine 630 may be connected, e.g., using the tongue and groove design, between two facing ends of two structural panels 610 that are aligned with each other such that the two structural panels 610 and the wind turbine 630 form at least a portion of a single wall. The rack 10, 12 and/or the mounting structure 200, 300, 400, 500 described above may be attached to the building structure 600 and/or the structural panels 610. The mounting structure 400, 500 may be substituted for the structural panels 610 on the roof of the building structure 600.

FIG. 21 shows electrical wires, fiber optic cable for communications, light tubes, plumbing, fluid-based solar systems, logic systems to monitor and control environmental conditions, HVAC components, and other features embedded into the structural panels 610 that connect together, e.g., using tongue and groove connections or other types of connections. Connections of these features between structural panels 610 may be completed through twist-locking connectors and require extended length of cable.

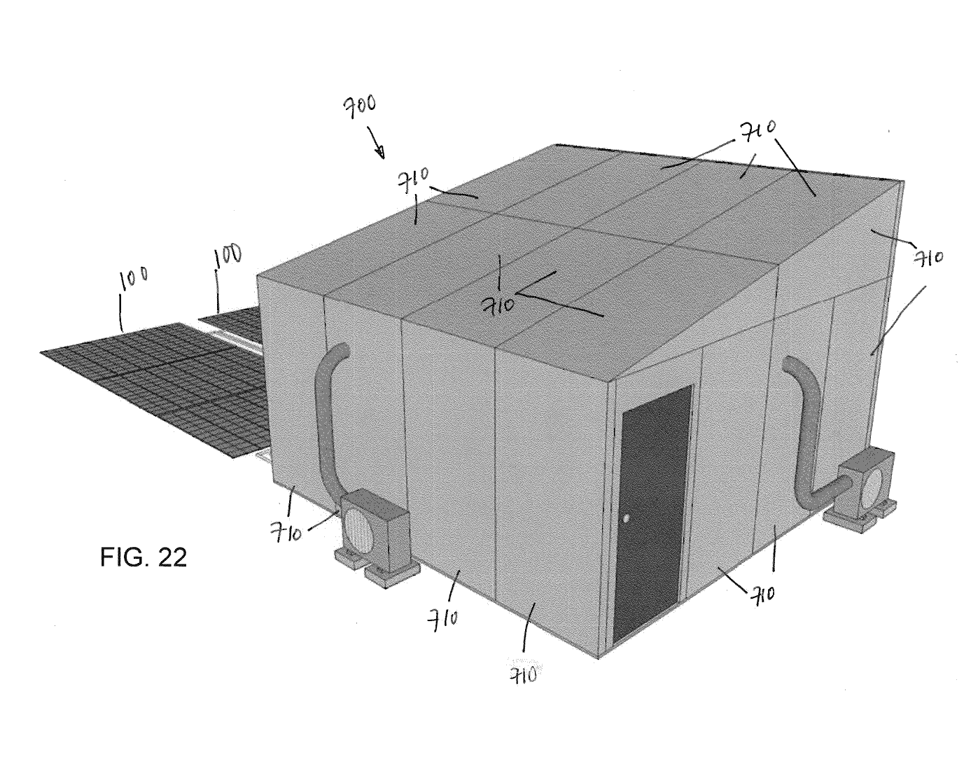

FIGS. 22-24 show a building structure 700 that may be formed of structural panels 710 (including wall, floor, ceiling panels, etc.) and other building materials described above. Although not shown, the structural building panels 710 shown in FIGS. 22-24 may be connected using the tongue and groove connectors shown in FIGS. 14, 16, 17, 19, and 21. Furthermore, the rack 10, 12, the wind turbine 630, the embedded power components described above and shown in FIG. 21, and other features described above and shown in the figures may be included in and/or attached to the structure 700 shown in FIGS. 22-24.

FIGS. 22-24 show the solar panels 100 attached to the building structure 700 and lying on the ground. Alternatively, the solar panels 100 may be attached to the rack 10, 12 and/or the mounting structure 200, 300, 400, 500 described above, which may be attached to the building structure 700 and/or the structural panels 710. The mounting structure 400, 500 may be substituted for the structural panels 710 on the roof of the building structure 700.

The rack 10, 12 may include watertight or water resistant protection for power panels and associated electronic connections. At least a portion of the rack 10, 12 may fold or compress to reduce size for ease of transport. At least a portion of the rack 10, 12 may be partially flexible to adjust to climate conditions or to better match with various solar panels 100 attached within the rack 10.

The solar panels 100 may be rapidly installed in walls, roofs, panels for forming a building structure, or other structures, and rapidly removed from those structures. In addition, the structures may be rapidly assembled with renewable energy systems (e.g., the solar panel(s) 100) pre-embedded in the panels that form the structure (including walls, floors, ceiling panels, and others building materials).

These structures may be particularly useful as replacements for products in such markets as those served by tents. A majority of the products in the tent market have a limited effective life for use and cannot be insulated. If tents are insulated by products such as spray foam, the tents lose their mobility and become permanent structures. These structures may also be equipped with electromagnetic frequency protection, blast protection, and many other features that current tent designs cannot support.

Any aspect set forth in any embodiment may be used with any other embodiment set forth herein. It will be apparent to those skilled in the art that various modifications and variations can be made in the disclosed systems and processes without departing from the scope of the invention. Other embodiments of the invention will be apparent to those skilled in the art from consideration of the specification and practice of the invention disclosed herein. It is intended that the specification and examples be considered as exemplary only. The following disclosure identifies some other exemplary embodiments.

What is claimed is:

1. An assembly for supporting at least one solar panel, the assembly comprising:
two side brackets, each side bracket including:
a top member having an L-shaped cross-section with a top portion substantially perpendicular to a side portion,
a bottom member having an L-shaped cross-section with a bottom portion substantially perpendicular to a side portion, and
a height adjustment mechanism connecting the side portions of the top and bottom members, and configured to adjust a height between the top and bottom members so that the top and bottom portions of each side bracket clamp onto respective top and bottom surfaces of at least one solar panel;
a width adjustment mechanism connecting the two side brackets and configured to adjust a width between the two side brackets;
wherein at least one of the side brackets includes a first connector configured to electrically connect to a second connector on the at least one solar panel.

2. The assembly of claim 1, wherein:
the height and width adjustment mechanisms each include a first member, a second member, and a fastening member connecting the first and second members;
the first member is configured to move with respect to the second member to adjust the respective height or width when the fastening member is loosened; and
the first member is prevented from moving with respect to the second member when the fastening member is tightened.

3. The assembly of claim 1, wherein the top and bottom members are substantially identical and generally form mirror images of each other with respect to a plane separating the top and bottom members.

4. The assembly of claim 1, wherein the two side brackets are separated by a first width in a first section of the assembly and a second width in a second section of the assembly, the first width being larger than the second width so that a first solar panel having a larger width may be clamped into the first section and a second solar panel having a smaller width may be clamped into the second section.

5. The assembly of claim 1, wherein the first and second connectors automatically form an electrical connection between the at least one solar panel and the at least one side bracket when the at least one solar panel is placed into a desired position in the at least one side bracket.

6. The assembly of claim 1, wherein the first connector includes a conductive surface or a spring-loaded connector configured to contact a respective spring-loaded connector or a conductive surface on the at least one solar panel.

7. The assembly of claim 1, wherein the first connector is formed on an inside surface of at least one of the side portions of at least one of the top members or bottom members.

8. The assembly of claim 1, wherein the side brackets and the width adjustment mechanism are configured to be recessed into or flush with a surface of a building structure.

9. The assembly of claim 1, further including a mounting structure, wherein the side brackets and the width adjustment mechanism form a rack, and the rack is attached to the mounting structure.

10. The assembly of claim 9, wherein the mounting structure includes a mechanism configured to adjust an angle of inclination of the rack.

11. The assembly of claim 9, wherein:
the mounting structure is configured to be positioned over an opening in a roof forming a skylight;
the mounting structure includes a support for the rack and a cover configured to close the opening; and
the support is configured to adjust an angle of inclination of the rack and the at least one solar panel.

12. The assembly of claim 9, wherein the mounting structure includes legs, one end of the rack is supported by the legs, and the other end of the rack is located in the same horizontal plane as an end of the legs.

13. The assembly of claim 9, wherein:
the mounting structure includes a pole configured to vertically support the entire rack above the ground and at least one extendable arm connected to the pole; and
the arm is configured to connect to the rack and adjust an angle of inclination of the rack and the at least one solar panel.

14. The assembly of claim 9, wherein the mounting structure includes a modular panel for a roof, the panel including a groove so that the width adjustment mechanism is inserted into the groove in the panel.

15. The assembly of claim 9, wherein:
the mounting structure includes a structural panel for a roof at a first location; and
the rack is detachable from the panel and configured to be attached to a second mounting structure at a second location.

16. The assembly of claim 15, wherein the second mounting structure is located on ground.

17. A skylight assembly for supporting a solar array, the skylight assembly comprising:
a cover configured to close an opening in a roof surface to form a skylight and having an adjustable angle of inclination to adjust an extent to which the cover closes the opening;
a rack connectable to a support, the support being configured to be positioned horizontally or at an angle of inclination; and
at least one solar panel configured to be connected to the rack such that an angle of inclination of the at least one solar panel varies with the angle of inclination of the support, the at least one solar panel being detachable from the rack.

18. The skylight assembly of claim 17, wherein the support covers the cover when the support is positioned horizontally.

19. The skylight assembly of claim 17, further including a mechanism attached to the cover and configured to control the extent to which the cover closes the opening.

20. A method of supporting at least one solar panel, the method comprising:
adjusting a width between two side brackets using a width adjustment mechanism connecting the two side brackets;
inserting at least one solar panel into the two side brackets so that the side edges of the at least one solar panel are received within the respective side brackets;
adjusting a height between a top member and a bottom member of each of the side brackets using height adjustment mechanisms of the respective side brackets;
clamping the side brackets onto the respective side edges of the at least one solar panel; and
automatically electrically connecting the at least one solar panel to at least one of the side brackets when the at least one solar panel is inserted into the two side brackets and placed at a desired position with respect to the two side brackets.

21. The method of claim 20, further including attaching at least one of the side brackets or the width adjustment mechanism to a mounting structure.

22. The method of claim 20, wherein the automatic electrical connection is established when a conductive surface of one of the side brackets or the at least one solar panel contacts a spring-loaded connector on the other one of the side brackets or the at least one solar panel.
